(19) United States
(12) Patent Application Publication
(10) Pub. No.: US 2023/0180281 A1
(43) Pub. Date: Jun. 8, 2023

(54) BI-DIRECTIONAL GATES FOR SCHEDULING OF WIRELESS NETWORKS

(71) Applicant: Cisco Technology, Inc., San Jose, CA (US)

(72) Inventors: Maik Guenter Seewald, Nurnberg (DE); Malcolm Muir Smith, Richardson, TX (US)

(73) Assignee: Cisco Technology, Inc., San Jose, CA (US)

(21) Appl. No.: 17/543,816

(22) Filed: Dec. 7, 2021

(51) Int. Cl. H04W 72/12; H04W 28/02; H04W 52/02

(52) U.S. Cl. CPC H04W 72/1236; H04W 72/1263; H04W 28/0268; H04W 52/0216

(57) ABSTRACT

Bi-directional gates for scheduling may be provided. Quality of Service (QoS) requirements for communication between an Access Point (AP) and a plurality of client devices may be received. Then schedules may be determined based on the QoS requirements. Next, an Access Point (AP) may be configured to enable the schedules. Configuring the AP may comprise defining traffic queue assignments for a plurality of traffic class queues on the AP to enable the schedules and defining gate control list entries for a respective plurality of bi-directional gates associated with the plurality of traffic class queues to enable the schedules.

### TECHNICAL FIELD

The present disclosure relates generally to scheduling of wireless networks.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for providing bi-directional gates for scheduling;

FIG. 2 is a flow chart of a method for providing bi-directional gates for scheduling;

FIG. 3 is a block diagram of an Access Point (AP); and

FIG. 4 is a block diagram of a computing device.

### DETAILED DESCRIPTION

### Overview

Bi-directional gates for scheduling may be provided. Quality of Service (QoS) requirements for communication between an Access Point (AP) and a plurality of client devices may be received. Then schedules may be determined based on the QoS requirements. Next, an Access Point (AP) may be configured to enable the schedules. Configuring the AP may comprise defining traffic queue assignments for a plurality of traffic class queues on the AP to enable the schedules and defining gate control list entries for a respective plurality of bi-directional gates associated with the plurality of traffic class queues to enable the schedules.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Conventional wireless (e.g., Wi-Fi) networks may not provide deterministic capabilities such as bounded low latency. Traffic scheduling using the features of a Time Sensitive Network (TSN) may comprise a mechanism in Ethernet networks to meet such strict latency requirements. It may also be implemented in the client devices (e.g., stations) and in the network infrastructure (e.g., bridges). On the bridges and in the Ethernet network, it may work simultaneously in both directions. However, this may not exist in conventional wireless networks and may represent a drawback for the deployment in many industrial use cases (e.g., in Operational Technology (OT) or Internet of Things (IoT)) where applications may implement control-loops that may require bounded low latency in both directions.

Embodiments of the disclosure may comprise processes for scheduling traffic based on bi-directional gates applied to traffic queues on an AP using, for example, Institute of Electrical and Electronics Engineers (IEEE) 802.11ax capabilities (e.g., Traffic Identifier (TID) prioritization, Enhanced Distributed Channel Access (EDCA) queuing). Accordingly, embodiments of the disclosure may allow a quasi-full-duplex operation that may be similar to the traffic in Ethernet networks implementing the features of IEEE 802.1 TSN for example.

Scheduled traffic as defined on IEEE 802.1Qbv may include a process to achieve bounded low latency. With embodiments of the disclosure, the scheduled frame transmission may be implemented and executed in an AP in a bi-directional way. This may require precise time synchronization and network configuration/management to enable scheduled network access as well as scheduled forwarding of frames. Consequently, embodiments of the disclosure may utilize, but are not limited to, the following specifications developed in the IEEE 802.1 TSN group: i) IEEE 802.1AS for generic Precise Time Synchronization (gPTP); and ii) IEEE 802.1Qcc for network configuration. For example, the centralized management model based on Centralized Network Configuration (CNC) and Centralized User Configuration (CUC) may be applied. The application of these standards that may be used in a TSN environment for Ethernet-based networks allows a reuse of them and may enable wireless (e.g., Wi-Fi) integration deeply with these technologies to achieve a hybrid network (i.e., wired and wireless) under the same administrative TSN domain.

The scheduling mechanism, consistent with embodiments of the disclosure, may comprise a functional block of an AP. It may follow IEEE 802.1Qbv (Enhancements for Scheduled Traffic) and may include a plurality of traffic queues. A gating mechanism may be attached to the traffic queues to enable the time-aware scheduling mechanism based on gate-open/gate-closed entries in a gate control list. The assignment of traffic to the queues may be based, for example, on an identification mechanism that may use a Traffic Identifier (TID) specified in IEEE 802.11. In other words, embodiments of the disclosure may utilize the TID to classify, assign, and schedule traffic on an AP. The gating mechanism functions (e.g., gate-open/gate-closed) may be based on a configurable gate control list. This mechanism may allow exclusive access to the media (i.e., link). Conventional system may be based on a port-based model (e.g., ingress and egress port) that works unidirectional.

Embodiments of the disclosure may provide a scheduling mechanism based on bi-directional gates applied to Down Link (DL) and Up Link (UL) transmission. Bi-directional gates may enable quasi-full-duplex traffic in a wireless (Wi-Fi) network. This may allow seamless integration, for example, with Ethernet networks that may implement TSN capabilities such as scheduled traffic and precise time synchronization. The scheduling mechanism, which may be computed by a CNC controller, may be aware of the traffic flow and may configure the bi-directional gates accordingly.

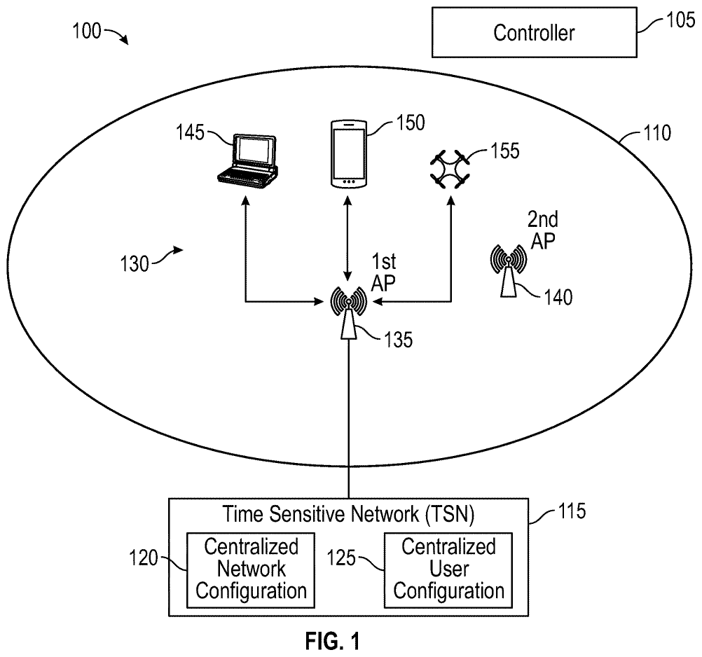

FIG. 1 shows an operating environment 100 for providing bi-directional gates for scheduling. As shown in FIG. 1, operating environment 100 may comprise a controller 105, a coverage environment 110, a Time Sensitive Network (TSN) 115, a Centralized Network Configuration (CNC) server 120, and a Centralized User Configuration (CUC) 125 server. Coverage environment 110 may comprise, but is not limited to, a Wireless Local Area Network (WLAN) comprising a plurality of stations 130. The plurality of stations 130 may comprise a plurality of Access Points (APs) and a plurality of client devices. At any given time, any one of the plurality of stations 130 may comprise an Initiating Station (ISTA) or a Responding Station (RSTA). The plurality of APs may provide wireless network access (e.g., access to the WLAN) for the plurality of client devices. The plurality of APs may comprise a first AP 135 and a second AP 140. Each of the plurality of APs may be compatible with specification standards such as, but not limited to, the Institute of Electrical and Electronics Engineers (IEEE) 802.11 specification standard for example. Coverage environment 110 may comprise, but is not limited to, an outdoor wireless environment, such as a mesh (e.g., a Wi-Fi mesh). Embodiments of the disclosure may also apply to indoor wireless environments and non-mesh environments.

Ones of the plurality of client devices may comprise, but are not limited to, a smart phone, a personal computer, a tablet device, a mobile device, a telephone, a remote control device, a set-top box, a digital video recorder, an Internet-of-Things (IoT) device, a network computer, a router, an Automated Transfer Vehicle (ATV), a drone, an Unmanned Aerial Vehicle (UAV), or other similar microcomputer-based device. In the example shown in FIG. 1, the plurality of client devices may comprise a first client device 145 (e.g., a laptop computer), a second client device 150 (e.g., a smart phone), and a third client device 155 (e.g., a drone).

Controller 105 may comprise a Wireless Local Area Network controller (WLC) and may provision and control operating environment 100 (e.g., the WLAN). Controller 105 may allow the plurality of client devices to join operating environment 100. In some embodiments of the disclosure, controller 105 may be implemented by a Digital Network Architecture Center (DNAC) controller (i.e., a Software-Defined Network (SDN) controller) that may configure information for operating environment 100 in order to provide bi-directional gates for scheduling consistent with embodiments of the disclosure.

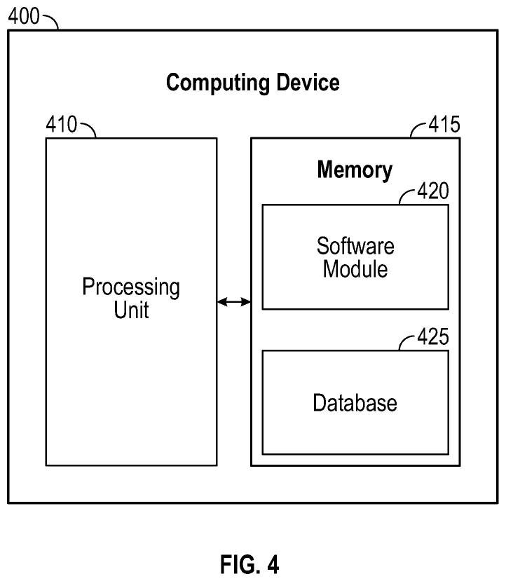

The elements described above of operating environment 100 (e.g., controller 105, CNC server 120, CUC, 125 server, first AP 135, second AP 140, first client device 145, second client device 150, and third client device 155) may be practiced in hardware and/or in software (including firmware, resident software, micro-code, etc.) or in any other circuits or systems. The elements of operating environment 100 may be practiced in electrical circuits comprising discrete electronic elements, packaged or integrated electronic chips containing logic gates, a circuit utilizing a microprocessor, or on a single chip containing electronic elements or microprocessors. Furthermore, the elements of operating environment 100 may also be practiced using other technologies capable of performing logical operations such as, for example, AND, OR, and NOT, including but not limited to, mechanical, optical, fluidic, and quantum technologies. As described in greater detail below with respect to FIG. 4, the elements of operating environment 100 may be practiced in a computing device 400.

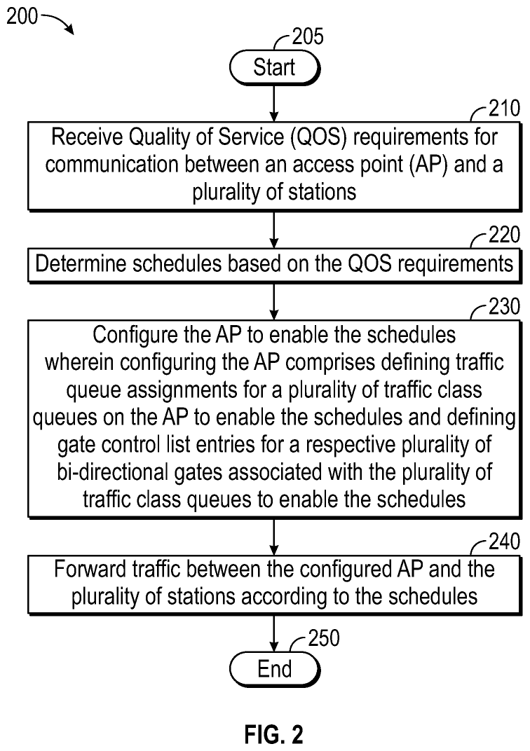

FIG. 2 is a flow chart setting forth the general stages involved in a method 200 consistent with an embodiment of the disclosure for providing bi-directional gates for scheduling. Method 200 may be implemented using CNC server 120 as described in more detail above with respect to FIG. 1. Ways to implement the stages of method 200 will be described in greater detail below.

Method 200 may begin at starting block 205 and proceed to stage 210 where CNC server 120 may receive Quality of Service (QoS) requirements for communication between first AP 135 and a plurality of client devices. For example, embodiments of the disclosure may configure and execute time-aware scheduling for bi-directional gates implemented in an AP (e.g., first AP 135). The configuration process may be performed by CNC server 120. CNC server 120 may receive the QoS requirements from a management and engineering tool or from CUC 125. Consistent with embodiments of the disclosure these requirements may comprise a time windows (e.g., representing the bounded latency) in which data is expected by the applications hosted on the plurality of client devices. In addition, these requirements may comprise the communication relations represented by a stream (e.g., sent from a sender/talker to a receiver(listener). Time windows may differ depending on the application requirements.

From stage 210, where CNC server 120 receives QoS requirements for communication between first AP 135 and the plurality of client devices, method 200 may advance to stage 220 where CNC server 120 may determine schedules based on the QoS requirements. For example, CNC server 120 may evaluate the QoS requirements and may compute the schedules.

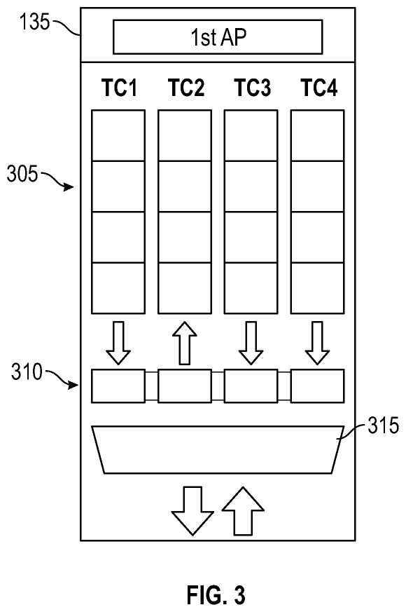

Once CNC server 120 determines schedules based on the QoS requirements in stage 220, method 200 may continue to stage 230 where CNC server 120 may configure first AP 135 to enable the schedules. Configuring first AP 135 may comprise defining traffic queue assignments for a plurality of traffic class queues on first AP 135 to enable the schedules and defining gate control list entries for a respective plurality of bi-directional gates associated with the plurality of traffic class queues to enable the schedules. For example, as shown in FIG. 3, first AP 135 may comprise a plurality of traffic class queues 305 and a respective plurality of bi-directional gates 310 associated with plurality of traffic class queues 305. While FIG. 3 shown four traffic class queues (i.e., TC1, TC2, TC3, and TC4), plurality of traffic class queues 305 may comprise any number of traffic class queues and is not limited to four. A transmission selector 315 may allow packets to pass to and from the media.

CNC server 120 may configure the APs (e.g., first AP 135 and second AP 140) including definitions of traffic class queues 305 assignments and gate control list entries to enable the scheduling. Based on the workflows, plurality of bi-directional gates 310 may be configured for bi-directional or unidirectional forwarding. The use of bi-directional gates 310 may enable the scheduled transmission in both directions (i.e., Down Link (DL) and Up Link (UL)). This may allow use cases that were not achievable with conventional Wi-Fi implementations, for example, control loop applications. At the WLAN (i.e., coverage environment 110), various embodiments of this bi-directional gate may comprise, but not limited to: i) 802.11ax Down Link (DL) Physical layer Protocol Data Unit (PPDU) followed by a triggered Up Link (UL) as part of a cascade sequence; and ii) 802.11ax Target Wake Time (TWT) service period (SP) with an Up Link (UL) Single User (SU) Physical layer Protocol Data Unit (PPDU) followed by a Down Link (DL) SU PPDU.

After CNC server 120 configures first AP 135 to enable the schedules in stage 230, method 200 may proceed to stage 240 where first AP 135 may forward traffic between first AP 135 and the plurality of client devices according to the schedules. For example, embodiments of the disclosure may provide full-duplex traffic over a wireless (e.g., Wi-Fi) network that may allow traffic scheduling in a process that may achieve bounded latency and deterministic behavior. These capabilities may be needed to meet the requirements in various industries related to Operational Technology (OT) or Internet of Things (IoT)) networking for example. Once first AP 135 forwards traffic between first AP 135 and the plurality of client devices according to the schedules in stage 240, method 200 may then end at stage 250.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing bi-directional gates for scheduling as described above with respect to FIG. 2. Computing device 400, for example, may provide an operating environment for controller 105, CNC server 120, CUC, 125 server, first AP 135, second AP 140, first client device 145, second client device 150, and third client device 155. Controller 105, CNC server 120, CUC, 125 server, first AP 135, second AP 140, first client device 145, second client device 150, and third client device 155 may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure

1. A method comprising:
receiving, by a computing device, Quality of Service (QoS) requirements for communication between an Access Point (AP) and a plurality of client devices;
determining schedules based on the QoS requirements; and
configuring the AP to enable the schedules wherein configuring the AP comprises;
defining traffic queue assignments for a plurality of traffic class queues on the AP to enable the schedules, and
defining gate control list entries for a respective plurality of bi-directional gates associated with the plurality of traffic class queues to enable the schedules.

2. The method of claim 1, further comprising forwarding traffic between the configured AP and the plurality of client devices according to the schedules.

3. The method of claim 1, wherein the QoS requirements include a time window in which data is expected by an applications hosted on one of the plurality of the client devices.

4. The method of claim 1, wherein the computing device comprises a Centralized Network Configuration CNC server.

5. The method of claim 1, wherein receiving QoS requirements comprises receiving the QoS requirements from a Centralized User Configuration (CUC) server.

6. The method of claim 1, wherein at least one of the plurality of bi-directional gates uses a Down Link (DL) Physical layer Protocol Data Unit (PPDU) followed by a triggered Up Link (UL) as part of a cascade sequence.

7. The method of claim 1, wherein at least one of the plurality of bi-directional gates uses a Target Wake Time (TWT) service period (SP) with an Up Link (UL) Single User (SU) Physical layer Protocol Data Unit (PPDU) followed by a Down Link (DL) SU PPDU.

8. A system comprising:
a memory storage; and
a processing unit coupled to the memory storage, wherein the processing unit is operative to:
receive Quality of Service (QoS) requirements for communication between an Access Point (AP) and a plurality of client devices;
determine schedules based on the QoS requirements; and
configure the AP to enable the schedules wherein the processing unit being operative to configure the AP comprises the processing unit being operative to:
define traffic queue assignments for a plurality of traffic class queues on the AP to enable the schedules, and
define gate control list entries for a respective plurality of bi-directional gates associated with the plurality of traffic class queues to enable the schedules.

9. The system of claim 8, wherein the QoS requirements include a time window in which data is expected by an applications hosted on one of the plurality of the client devices.

10. The system of claim 8, wherein the processing unit is disposed in a Centralized Network Configuration CNC server.

11. The system of claim 8, wherein the processing unit being operative to receive QoS requirements comprises the processing unit being operative to receive the QoS requirements from a Centralized User Configuration (CUC) server.

12. The system of claim 8, wherein at least one of the plurality of bi-directional gates uses a Down Link (DL) Physical layer Protocol Data Unit (PPDU) followed by a triggered Up Link (UL) as part of a cascade sequence.

13. The system of claim 8, wherein at least one of the plurality of bi-directional gates uses a Target Wake Time (TWT) service period (SP) with an Up Link (UL) Single User (SU) Physical layer Protocol Data Unit (PPDU) followed by a Down Link (DL) SU PPDU.

14. A computer-readable medium that stores a set of instructions which when executed perform a method executed by the set of instructions comprising:
receiving, by a computing device, Quality of Service (QoS) requirements for communication between an Access Point (AP) and a plurality of client devices;
determining schedules based on the QoS requirements; and
configuring the AP to enable the schedules wherein configuring the AP comprises;
defining traffic queue assignments for a plurality of traffic class queues on the AP to enable the schedules, and
defining gate control list entries for a respective plurality of bi-directional gates associated with the plurality of traffic class queues to enable the schedules.

15. The computer-readable medium of claim 14, further comprising forwarding traffic between the configured AP and the plurality of client devices according to the schedules.

16. The computer-readable medium of claim 14, wherein the QoS requirements include a time window in which data is expected by an applications hosted on one of the plurality of the client devices.

17. The computer-readable medium of claim 14, wherein the computing device comprises a Centralized Network Configuration CNC server.

18. The computer-readable medium of claim 14, wherein receiving QoS requirements comprises receiving the QoS requirements from a Centralized User Configuration (CUC) server.

19. The computer-readable medium of claim 14, wherein at least one of the plurality of bi-directional gates uses a Down Link (DL) Physical layer Protocol Data Unit (PPDU) followed by a triggered Up Link (UL) as part of a cascade sequence.

20. The computer-readable medium of claim 14, wherein at least one of the plurality of bi-directional gates uses a Target Wake Time (TWT) service period (SP) with an Up Link (UL) Single User (SU) Physical layer Protocol Data Unit (PPDU) followed by a Down Link (DL) SU PPDU.
